(19) United States
(12) Patent Application Publication
(10) Pub. No.: US 2014/0197915 A1
(43) Pub. Date: Jul. 17, 2014

(54) ELECTRONIC COMPONENT

(71) Applicant: TAIYO YUDEN CO., LTD., Tokyo (JP)

(72) Inventors: Masahiro SATO, Kanagawa (JP); Motoyuki TAJIMA, Kanagawa (JP); Kaoru SAKINADA, Kanagawa (JP)

(73) Assignee: TAIYO YUDEN CO., LTD., Tokyo (JP)

(21) Appl. No.: 14/091,851

(22) Filed: Nov. 27, 2013

(30) Foreign Application Priority Data
Jan. 11, 2013 (JP) 2013-003825

(51) Int. Cl. H01F 27/29

(52) U.S. Cl. CPC H01F 27/29
USPC 336/192

(57) ABSTRACT

An electronic component includes: a wiring substrate; a passive component that includes a substrate, a coil located on an upper surface of the substrate, and a terminal located on a lower surface of the substrate and electrically connected to the coil, and is mounted on an upper surface of the wiring substrate by using the terminal; and a grounding wiring that is located on the wiring substrate and overlaps with the coil in a thickness direction of the wiring substrate.

### CROSS-REFERENCE TO RELATED APPLICATION

This application is based upon and claims the benefit of priority of the prior Japanese Patent Application No. 2013-003825, filed on Jan. 11, 2013, the entire contents of which are incorporated herein by reference.

### FIELD

A certain aspect of the present invention relates to an electronic component.

### BACKGROUND

Electronic components installed in communication devices such as mobile phones are required to be downsized and have good frequency characteristics. To reduce the size, a duplexer and other components may be integrated into a single electronic component. Passive components such as an inductor for impedance matching are installed as the component. Japanese Patent Application Publication No. 2006-157738 discloses an invention that forms an inductor and a capacitor on a single substrate. Japanese Patent Application Publication Nos. 2007-67236 and 2009-88163 disclose an invention that stacks two coils. Japanese Patent Application Publication No. 9-205314 discloses an invention that connects an inductor and a capacitor to an antenna on a glass of a vehicle. Japanese Patent Application Publication No. 2002-280219 discloses a coil formed by metal layers.

However, the conventional techniques may decrease the Q-value of the passive component, and thus deteriorate frequency characteristics of the electronic component.

### SUMMARY OF THE INVENTION

According to an aspect of the present invention, there is provided an electronic component including: a wiring substrate; a passive component that includes a substrate, a coil located on an upper surface of the substrate, and a terminal located on a lower surface of the substrate and electrically connected to the coil, and is mounted on an upper surface of the wiring substrate by using the terminal; and a grounding wiring that is located on the wiring substrate and overlaps with the coil in a thickness direction of the wiring substrate.

### BRIEF DESCRIPTION OF THE DRAWINGS

FIG. 1A is a top view illustrating an electronic component in accordance with a first embodiment, FIG. 1B is a cross-sectional view illustrating the electronic component, and FIG. 1C is a circuit diagram of the electronic component;

FIG. 2A is a cross-sectional view illustrating an IPD, FIG. 2B is a top view illustrating the IPD, and FIG. 2C is a bottom view illustrating the IPD;

FIG. 3 is a cross-sectional view illustrating an electronic component in accordance with a comparative example;

FIG. 4A through FIG. 4F are cross-sectional views illustrating a method of fabricating the IPD;

FIG. 5A through FIG. 5E are cross-sectional views illustrating the method of fabricating the IPD;

FIG. 6 is a cross-sectional view illustrating the IPD;

FIG. 7A is a plan view illustrating an electronic component in accordance with a second embodiment, FIG. 7B is a cross-sectional view illustrating the electronic component, and FIG. 7C is a cross-sectional view illustrating a duplexer; and

FIG. 8 is a cross-sectional view illustrating an electronic component in accordance with a third embodiment.

### DETAILED DESCRIPTION

A description will be given of embodiments with reference to the drawings.

### First Embodiment

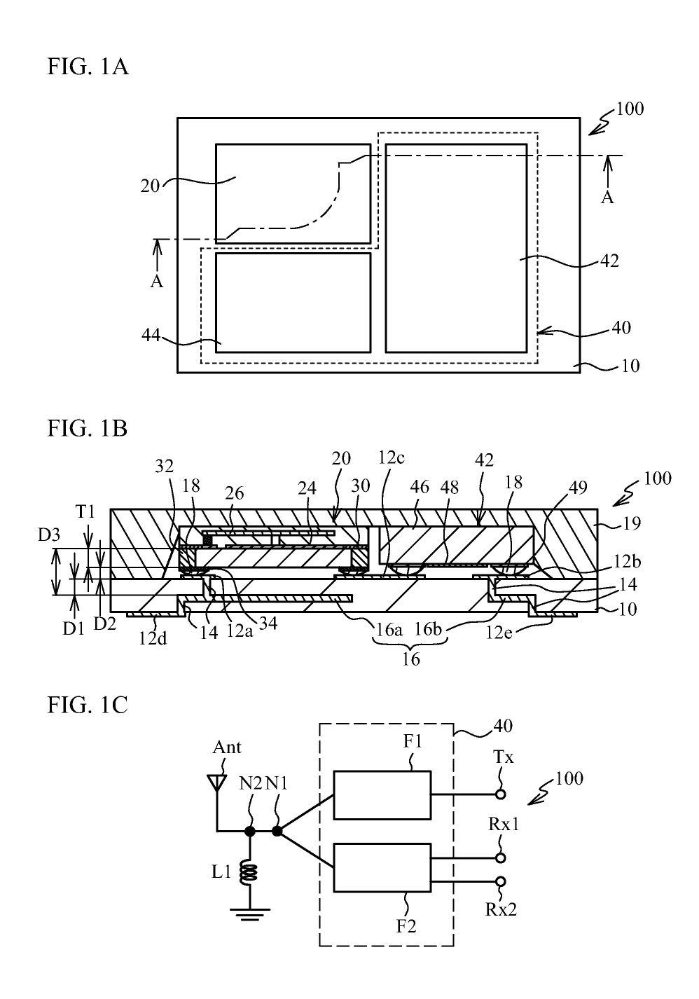

FIG. 1A is a top view illustrating an electronic component 100 in accordance with a first embodiment. FIG. 1B is a cross-sectional view illustrating the electronic component 100, and illustrates a cross-section taken along line A-A in FIG. 1A. FIG. 1C is a circuit diagram of the electronic component 100. In FIG. 1B, a part of reference numerals for elements included in an IPD 20 is omitted.

As illustrated in FIG. 1A and FIG. 1B, the electronic component 100 includes a wiring substrate 10, the IPD (Integrated Passive Device) 20, and a duplexer 40. The duplexer 40 includes a transmit filter chip 42 and a receive filter chip 44. The IPD 20 and the duplexer 40 are mounted on the wiring substrate 10 by solder 18.

The wiring substrate 10 is a multilayered substrate formed by stacking metal layers and insulating layers. Terminals 12a-12c are located on the upper surface of the wiring substrate 10, and terminals 12d and 12e are located on the lower surface. An internal wiring 16 includes a grounding wiring 16a and a signal wiring 16b. The terminal 12a is electrically connected to the terminal 12d through a via wiring 14 and the grounding wiring 16a. The terminal 12b is electrically connected to the terminal 12e through the via wiring 14 and the signal wiring 16b. The insulating layer of the wiring substrate 10 is formed of an insulating material such as a resin or ceramic. The terminals, the via wirings 14, and the internal wiring 16 have a structure that stacks metals such as copper, nickel, and gold in this order from the wiring substrate 10 side (Cu/Ni/Au). The solder 18 is primarily composed of tin silver (Sn—Ag). Instead of the solder 18, a bump made of Au may be used.

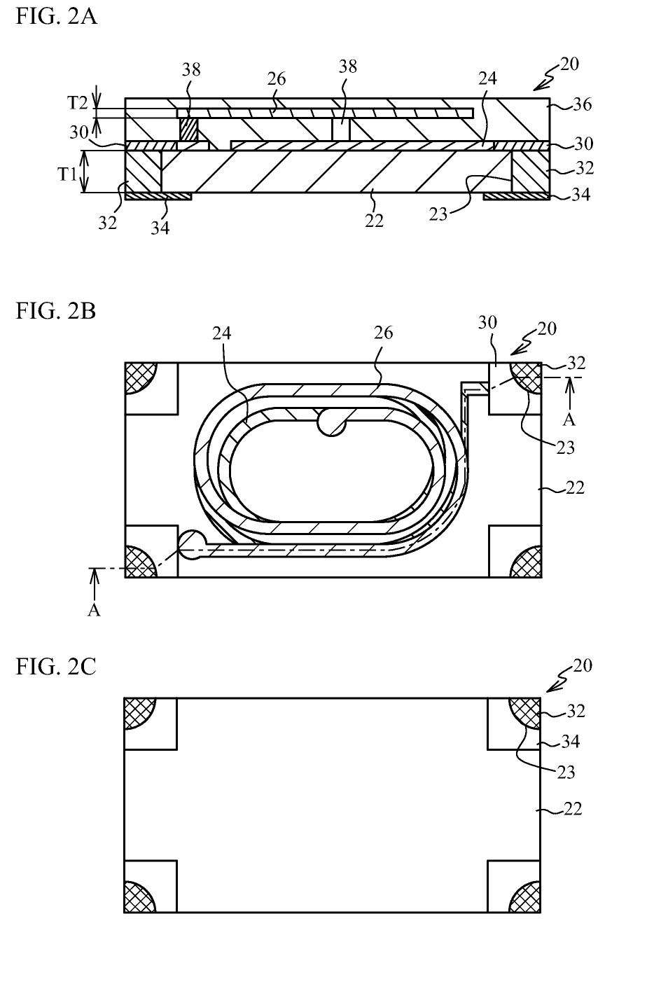

FIG. 2A is a cross-sectional view illustrating the IPD 20. FIG. 2B is a top view illustrating the IPD 20, and illustrates a sealing portion 19 transparently. FIG. 2C is a bottom view illustrating the IPD 20. A coil 24 is indicated by a bold hatched line, a coil 26 is indicated by a thin hatched line, and wirings 32 are indicated by a grid hatched line.

As illustrated in FIG. 2A through FIG. 2C, the IPD 20 includes a substrate 22, the coils 24 and 26, terminals 30 and 34, the wirings 32, and a sealing portion 36. The coils 24 and 26 (collectively referred to as a coil) are spiral inductors formed by a metal layer primarily composed of copper (Cu). The coil is wound in the surface direction of the upper surface of the substrate 22. The coil 24 is located so as to make contact with the upper surface of the substrate 22. The coil 26 is located away from the substrate 22, and is supported by supporting posts 38. The supporting post 38 electrically connects the coil 24 and the coil 26. The terminals 30 are located on the upper surface of the substrate 22, and the terminals 34 are located on the lower surface of the substrate 22. Grooves 23 are formed at four corners of the substrate 22 from the upper surface to the lower surface. The wirings 32 are located in the grooves 23. The coil 24 is electrically connected to the terminal 30. The wiring 32 pierces through the substrate 22 in the thickness direction, and electrically connects the terminal 30 and the terminal 34. The sealing portion 36 seals the coils.

The substrate 22 is a printed substrate formed by, for example, FR4 (Flame Retardant type 4), and has a thickness of, for example, 100 μm. The coils 24 and 26, the wirings 32, and the supporting posts 38 are formed of a metal such as Cu. The terminals 30 and 34 are formed of a metal such as Cu/Ni/Au. The sealing portion 36 is formed of, for example, an epoxy resin.

The transmit filter chip 42 is a SAW (Surface Acoustic Wave) filter chip including a piezoelectric substrate 46, an IDT 48, and terminals 49. The IDT 48 and the terminals 49 are located on the lower surface of the piezoelectric substrate 46. The receive filter chip 44 has the same structure as the transmit filter chip 42. The piezoelectric substrate 46 is formed of a piezoelectric substance such as lithium niobate (LiNbO₃) or lithium tantalate (LiTaO₃). The IDT 48 is formed of a metal such as aluminum (Al). The terminal 49 has a structure of Cu/Ni/Au.

As illustrated in FIG. 1B, the terminals 34 of the IPD 20 are electrically connected to the terminals 12a and 12c through the solder 18. The IPD 20 is face-up mounted on the wiring substrate 10. The terminal 49 of the transmit filter chip 42 is electrically connected to the terminals 12b and 12c of the wiring substrate 10 by the solder 18. The terminal 12c is an antenna terminal, and commonly connected to the IPD 20 and the filter chip, and further connected to an antenna not illustrated. The IDT 48 faces and is located away from the upper surface of the wiring substrate 10. As described above, the transmit filter chip 42 and the receive filter chip 44 (collectively referred to as a filter chip) are flip-chip mounted on the wiring substrate 10. The IPD 20 and the filter chip are sealed by the sealing portion 19 formed of, for example, an epoxy resin.

As illustrated in FIG. 1C, the duplexer 40 includes a transmit filter F1 and a receive filter F2. The transmit filter chip 42 includes the transmit filter F1, and the receive filter chip 44 includes the receive filter F2. An inductor L1 is formed by the IPD 20. A first end of the transmit filter F1 is coupled to a transmit terminal Tx. A first end of the receive filter F2 is coupled to receive terminals Rx1 and Rx2 that are balanced terminals. Second ends of the transmit filter F1 and the receive filter F2 are interconnected at a node N1. A first end of the inductor L1 is coupled to a node N2 located between the node N1 and an antenna Ant. A second end of the inductor L1 is grounded. That is to say, the terminal 12d in FIG. 1B is a ground terminal. The nodes N1 and N2 are, for example, the terminal 12c included in the wiring substrate 10. The transmit terminal Tx corresponds to the terminal 12e in FIG. 1B.

The antenna Ant transmits/receives a high-frequency signal to/from the outside of the electronic component 100. A transmission signal input from the transmit terminal Tx is filtered by the transmit filter F1, and then transmitted from the antenna Ant to the outside of the electronic component 100. A reception signal received by the antenna Ant is filtered by the receive filter F2, and then output from the receive terminals Rx1 and Rx2. The inductor L1 matches impedance between the duplexer 40 and the antenna Ant. That is to say, the IPD 20 performs the impedance matching.

As illustrated in FIG. 1B, the IPD 20 is face-up mounted on the wiring substrate 10. Thus, the distance between the grounding wiring 16a and the coils 24 and 26 is large. Therefore, the electromagnetic coupling between the coils 24 and 26 and the grounding wiring 16a is reduced, and thus the Q-value of the IPD 20 increases. Thus, the insertion loss of the IPD 20 decreases, and frequency characteristics of the electronic component 100 are improved. For example, a distance D1 between the grounding wiring 16a and the upper surface of the wiring substrate 10 is 50 μm, and a distance D2 between the wiring substrate 10 and the substrate 22 is 10 μm. The substrate 22 has a thickness T1 of 100 μm. A distance D3 between the grounding wiring 16a and the coil 24 is 160 μm. As described above, the IPD 20 with a high Q-value is used to match impedance. Thus, the frequency characteristics of the electronic component 100 are improved.

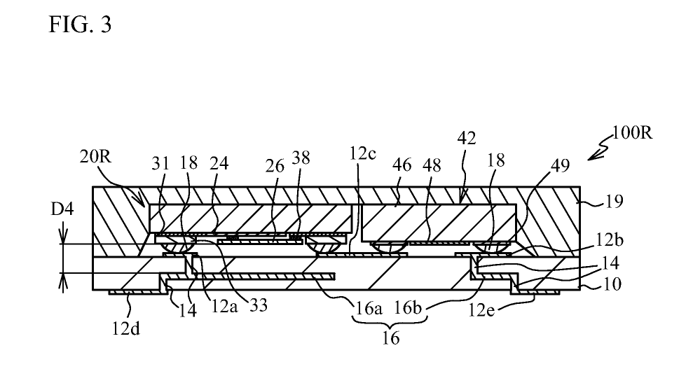

A comparative example face-down mounts the IPD. FIG. 3 is a cross-sectional view illustrating an electronic component 100R in accordance with the comparative example.

As illustrated in FIG. 3, the coils 24 and 26, wirings 31, and terminals 33 are located on the lower surface of a substrate 22R of an IPD 20R. The coils 24 and 26 are electrically connected to the terminals 33 through the wirings 31. The terminals 33 are coupled to the terminals 12a and 12c of the wiring substrate 10 by the solder 18. As described above, the IPD 20R is face-down mounted on the wiring substrate 10.

The comparative example has a distance between the grounding wiring 16a and the coils 24 and 26 less than that of the first embodiment. For example, a distance D4 between the grounding wiring 16a and the coil 26 is 70 μm. In the comparative example, as the distance D4 is small, the Q-value deteriorates and is, for example, 28. In the first embodiment, the Q-value is, for example, 50 and approximately twice that of the comparative example.

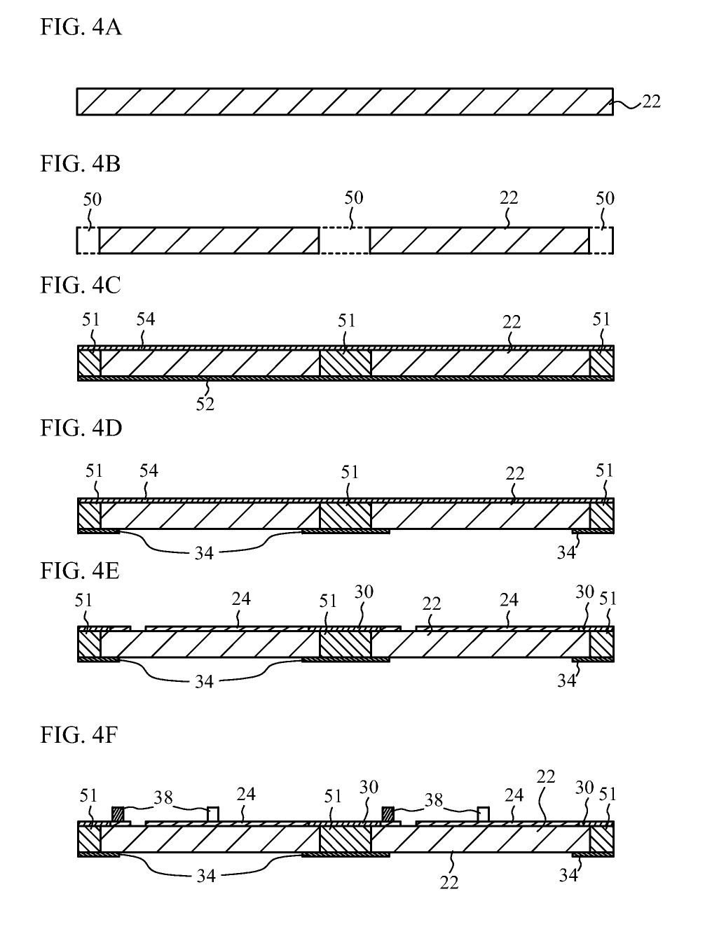

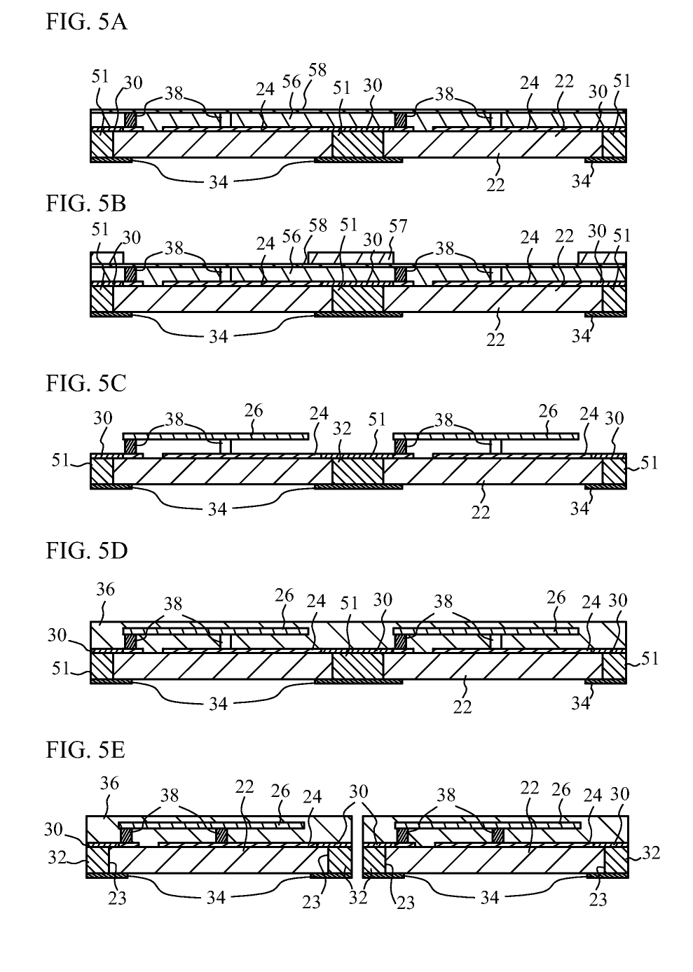

A description will be given of a method of fabricating the IPD 20. FIG. 4A through FIG. 5E are cross-sectional views illustrating the method of fabricating the IPD 20.

As illustrated in FIG. 4A, prepared is the substrate 22 in a wafer state. As illustrated in FIG. 4B, through-holes 50 piercing through the substrate 22 are formed by, for example, a laser beam. As illustrated in FIG. 4C, a metal layer 51 is formed in the through-holes 50 by, for example, electrolytic plating or electroless plating. A metal layer 52 is formed on the lower surface of the substrate 22, and a metal layer 54 is formed on the upper surface. As illustrated in FIG. 4D, the terminals 34 are formed from the metal layer 52 by etching. As illustrated in FIG. 4E, the coils 24 and the terminals 30 are formed from the metal layer 54 by etching. As illustrated in FIG. 4F, the supporting posts 38 are formed on the coils 24 by, for example, electrolytic plating.

As illustrated in FIG. 5A, a resist 56 is formed on the upper surface of the substrate 22. The upper surface of the resist 56 forms the same plane as the upper surface of the supporting post 38. A seed metal 58 is formed on the supporting posts 38 and the resist 56. The seed metal 58 is formed by stacking titanium and Cu in this order from the resist 56 side (Ti/Cu). The seed metal 58 covers the whole of the upper surface of the substrate 22. As illustrated in FIG. 5B, a resist 57 is formed on the resist 56. The coils 26 are formed by electrolytic plating by using the seed metal 58 as an electrical supply line. Plated Cu is integrated with the seed metal 58 to form the coils 26. As illustrated in FIG. 5C, the resists 56 and 57 and the seed metal 58 are removed by etching. As illustrated in FIG. 5D, the coils are sealed by the sealing portion 36 by, for example, mold forming. As illustrated in FIG. 5E, the substrate 22, the sealing portion 36, and the metal layer 51 are cut to produce individual devices. The through-holes 50 form the grooves 23. The IPD 20 is formed through the above-described process.

The substrate 22 may be a printed substrate as described above, or an insulating substrate formed of a resin such as polyimide. Forming the substrate 22 from a resin enables to easily form the through-holes 50. In addition, the substrate 22 is less broken than a substrate made of a glass. Therefore, the yield ratio is improved. When the substrate 22 is a polyimide substrate, the thickness thereof is, for example, 50 μm. The coils 24 and 26 and the wirings 32 can be formed more easily by electrolytic plating. After the metal layer 51 is formed in the through-hole 50, the substrate 22 is cut at the position overlapping with the metal layer 51. Thus, the wirings 32 can be efficiently formed. Therefore, the cost of the IPD 20 can be reduced.

As illustrated in FIG. 2B, the wirings 32 are formed in the grooves 23, and extend from the upper surface to the lower surface of the substrate 22. This enables to electrically connect the coils 24 and 26 on the upper surface of the substrate 22 to the terminals 34 on the lower surface. In addition, the wirings 32 are located at, for example, four corners of the substrate 22, and thus the substrate can be downsized. In addition, the chip-type IPD 20 is mounted, and thus the electronic component 100 can be reduced in size and height. The IPD 20 has a thickness of, for example, 150˜200 μm. In addition, the coil can be thickened, and thus a Q-value is improved. The coil 26 has a thickness T2 of, for example, 15 μm. The coil 24 may have the same thickness as or a different thickness from the coil 26. The coil is a spiral inductor, and thus can be reduced in size compared to a winding coil formed by winding a conductive wire.

The coil is wound in the surface direction of the substrate 22. Thus, a magnetic field toward the substrate 22 is generated, and the coupling easily occurs. Especially, two coils are stacked, and thus the magnetic field further increases. In the first embodiment, the distance D3 is large, and thus the magnetic field coupled to the grounding wiring 16a is small. Therefore, the coupling is reduced, and the Q-value increases. “Wound in the surface direction” means that a radial direction of the coil is the same as or approximately same as the surface direction of the upper surface. The coil may be wound in a direction different from the surface direction of the upper surface of the substrate 22.

The wiring substrate 10 may be a substrate other than the multilayered substrate. The grounding wiring 16a may be located on the upper surface or the lower surface of the wiring substrate 10 so as to overlap with the coil. In the above cases, the distance D3 is also large, and thus a high Q-value can be obtained.

As illustrated in FIG. 1A and FIG. 1B, the shape of the IPD 20 is, for example, a cuboid. Therefore, alignment, image recognition, and handling by the production device are easy. Thus, it is easy to work with the IPD 20. The IPD 20 may include one coil, or three or more coils. A capacitor may be mounted in the IPD 20. This enables to perform impedance matching appropriately.

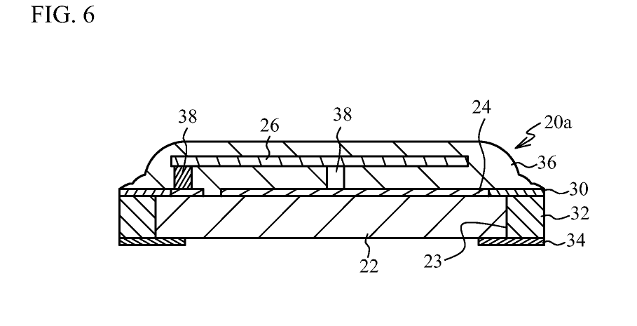

FIG. 6 is a cross-sectional view illustrating an IPD 20a. As illustrated in FIG. 6, the sealing portion 36 is formed by potting. The use of potting enables to reduce the amount of a resin.

### Second Embodiment

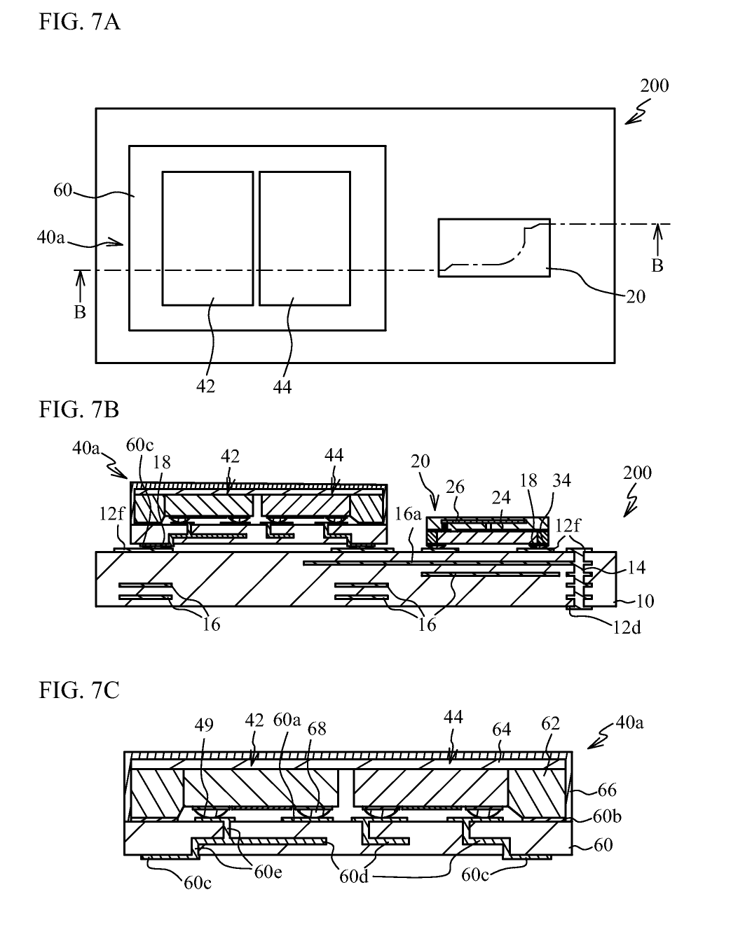

A second embodiment changes a layout on the upper surface of the wiring substrate 10. FIG. 7A is a plan view illustrating an electronic component 200 in accordance with the second embodiment. FIG. 7B is a cross-sectional view illustrating the electronic component 200, and illustrates a cross-section taken along line B-B in FIG. 7A. A part of numeral references for the IPD 20 and a duplexer 40a is omitted in FIG. 7B.

As illustrated in FIG. 7A and FIG. 7B, the electronic component 200 includes the wiring substrate 10, the IPD 20, and the duplexer 40a. The duplexer 40a is a chip, and flip-chip mounted on the wiring substrate 10. The IPD 20 is face-up mounted as with the first embodiment. The detailed description will be given later.

FIG. 7C is a cross-sectional view illustrating the duplexer 40a. As illustrated in FIG. 7C, the duplexer 40a includes a substrate 60, the transmit filter chip 42, the receive filter chip 44, a sealing portion 62, a lid 64, and a metal layer 66. Terminals 60a and 60b are located on the upper surface of the substrate 60, and terminals 60c are located on the lower surface of the substrate 60. Internal wirings 60d and via wirings 60e electrically connect the terminals 60a to the terminals 60c.

The terminal 49 that is a filter chip is electrically connected to the terminal 60a through solder 68. As described above, the filter chip is flip-chip mounted on the substrate 60. The terminal 60b is located in an outer periphery portion of the substrate 60 and surrounds the filter chip. The sealing portion 62 is bonded to the terminal 60b, surrounds the filter chip, and makes contact with the side surface of the filter chip. The lid 64 is located on the filter chip and the sealing portion 62. The sealing portion 62 and the lid 64 seal the filter chip. The metal layer 66 covers the surfaces of the sealing portion 62 and the lid 64.

As illustrated in FIG. 7B, two or more terminals 12f are located on the upper surface of the wiring substrate 10, and the two or more internal wirings 16 are located thereinside. The grounding wiring 16a of the internal wirings 16 is located so as to overlap with the coils 24 and 26 in the thickness direction. The via wiring 14 and the internal wirings 16 electrically connect the terminal 12f to the terminal 12d. The terminal 34 of the IPD 20 and the terminal 60c of the duplexer 40a are coupled to the terminal 12f of the wiring substrate 10 by the solder 18.

The second embodiment can obtain a high Q-value as with the first embodiment. As described in the second embodiment, the layout on the upper surface of the wiring substrate 10 can be changed. In addition, the filter chip can be protected by the sealing portion 62, the lid 64, and the metal layer 66. Furthermore, the IPD 20 and the duplexer 40 may be sealed by, for example, a resin.

### Third Embodiment

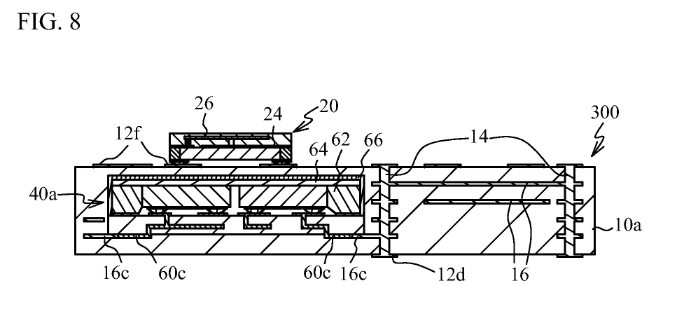

A third embodiment embeds the duplexer 40a in the wiring substrate 10. FIG. 8 is a cross-sectional view illustrating an electronic component 300 in accordance with the third embodiment.

As illustrated in FIG. 8, the duplexer 40a is embedded in the inside of a wiring substrate 10a. An internal wiring 16c of the internal wirings 16 included in the wiring substrate 10a is electrically connected to the terminal 60c of the duplexer 40a. The IPD 20 overlaps with the duplexer 40a in the thickness direction.

The sealing portion 62, the lid 64, and the metal layer 66 of the duplexer 40a have a ground potential, and function as a grounding wiring. Thus, the coil overlaps with the grounding wirings (the sealing portion 62, the lid 64, and the metal layer 66). In the third embodiment, the IPD 20 is face-up mounted, and thus the distance D3 between the metal layer 66 and the coils 24 and 26 is large. Therefore, a high Q-value can be obtained. The wiring substrate 10a may be downsized. In addition, other components may be mounted on the upper surface of the wiring substrate 10a.

The filter chip may include a boundary acoustic wave filter, or an acoustic wave filter such as a filter using an FBAR (Film Bulk Acoustic Resonator) instead of the SAW filter. The electronic component may include an acoustic wave filter instead of the duplexer 40. The electronic component may include other components such as a capacitor. This enables to perform impedance matching accurately.

Although the embodiments of the present invention have been described in detail, it is to be understood that the various change, substitutions, and alterations could be made hereto without departing from the spirit and scope of the invention.

What is claimed is:

1. An electronic component comprising:
a wiring substrate;
a passive component that includes a substrate, a coil located on an upper surface of the substrate, and a terminal located on a lower surface of the substrate and electrically connected to the coil, and is mounted on an upper surface of the wiring substrate by using the terminal; and
a grounding wiring that is located on the wiring substrate and overlaps with the coil in a thickness direction of the wiring substrate.

2. The electronic component according to claim 1, wherein
a groove is formed on a side surface of the substrate from the upper surface to the lower surface of the substrate, and
the electronic component further comprises a wiring that is located in the groove and electrically connects the coil to the terminal.

3. The electronic component according to claim 1, wherein
the coil is a spiral inductor wound in a surface direction of the upper surface of the substrate.

4. The electronic component according to claim 1, further comprising:
a duplexer that is mounted on the wiring substrate and electrically coupled to the passive component,
wherein the wiring substrate includes an antenna terminal,
the duplexer is electrically coupled to an antenna that transmits and receives a signal to and from an outside of the electronic component through the antenna terminal, and
the passive component matches impedance between the duplexer and the antenna.

5. The electronic component according to claim 4, wherein
the coil is connected between the antenna terminal and a ground terminal.

6. The electronic component according to claim 1, wherein
the substrate is formed of a resin.

7. The electronic component according to claim 1, wherein
a plurality of the coils overlapping with each other in a thickness direction of the substrate are provided.
